(19) United States
(12) Patent Application Publication
(10) Pub. No.: US 2013/0032676 A1
(43) Pub. Date: Feb. 7, 2013

(54) METHOD AND APPARATUS FOR RETAINING CABLES AND FIBRES

(71) Applicant: Paul Chapman, Sharpthorne (GB)

(72) Inventor: Paul Chapman, Sharpthorne (GB)

(73) Assignee: Technetix B.V., Veenendaal (NL)

(21) Appl. No.: 13/565,338

(22) Filed: Aug. 2, 2012

(30) Foreign Application Priority Data
Aug. 3, 2011 (GB) 1113384.0
Jan. 25, 2012 (GB) 1201219.1

(51) Int. Cl. F16L 3/00

(52) U.S. Cl. 248/68.1

(57) ABSTRACT

There is provided a method of retaining elongate elements, such as cables, glass fibres, wires or connectors, comprising attaching a hook strip to a surface and placing one or more elongate elements onto the hook strip so as to be removably secured by the hook strip. The hook strip comprises a number of upstanding catch elements to retain the elongate elements. This method provides a straightforward way of securing cables, glass fibres and the like and the elongate elements can be repositioned as and when needed with ease simply by pulling them from the hook strip to release them and then urging them back into the hook strip to be retained once again. A fibre management enclosure is also provided with rotatable spools for storing fibres ready for access.

### RELATED APPLICATIONS

The present application claims priority to United Kingdom Patent Application Nos. 1113384.0, filed on Aug. 3, 2011, and 1201219.1, filed on Jan. 25, 2012, the complete disclosures of which are hereby incorporated by reference.

### FIELD

This invention relates to a method of retaining cables and fibres and associated apparatus.

### BACKGROUND

Cables, fibres, wires and the like are often retained within specialised housings to protect them from damage and to prevent them from becoming tangled. This is particularly important for delicate fibres such as fibre optics. There are many types of housings designed to retain cables and fibres but these are often quite complex and it can be time consuming to position individual cables or fibres within such housings.

### SUMMARY

In accordance with one aspect of the present invention, there is provided a method of retaining elongate elements, such as cables, glass fibres, wires or connectors, comprising attaching a hook strip to a surface and placing one or more elongate elements onto the hook strip so as to be removably secured by the hook strip. This method of cable management provides a straightforward method of securing cables, glass fibres and the like which is quick and easy to use and the elongate elements can be repositioned as and when needed with ease simply by pulling them from the unmated hook strip to release them and then urging them back into the hook strip to be retained once again. Each elongate element placed on the hook strip is held firmly by hooks of the lock strip enfolding it but can be removed without physical stress occurring to the element, which is particularly important when using glass fibres such as fibre optics.

In accordance with another aspect of the invention, there is provided an article requiring cable management which has an attachment surface, wherein a hook strip of an interlocking fastener is attached to the attachment surface to allow elongate elements to be removably secured.

Preferably the hook strip comprises a number of upstanding catch elements to retain the elongate hermaphroditic mechanical fastener used in its unmated condition and elements. Desirably the upstanding catch elements are formed in rows.

Preferably the hook strip is a mushroom-type hook strip such as 3M® Dual Lock® or equivalent hermaphroditic mechanical fastener used in its unmated condition and which will provide gaps between the rows of between 3-1 mm. As will be understood by those skilled in the art, different gap widths may be provided between the rows depending on the application concerned and the diameter of the elongate elements. The invention is scaleable such that with an appropriate hook strip, elongate elements of larger diameter can be retained, and typically diameters of up to 2 cm can be retained.

In accordance with another aspect of the invention, there is provided a fibre management device comprising a base plate having a rear face for attachment to a support and a front face for receiving a housing and further comprising one or more rotatable spools extending from the rear face, the rotatable spools having attachment means for receiving cables or fibres. By having rearwardly depending rotatable spools, the fibre management device is able to utilise storage space in an existing wall enclosure box to which it is attached. This avoids the need for the cables or fibres to be retained in the cable management device itself as the rotating spools retain the fibres securely and allow the fibres to be accessed from the front face as and when required.

The attachment means is preferably hook strip as discussed above.

Where two or more rotatable spools are provided, the spools are preferably stacked along a common axis. Where stacked spools are provided, locating spigots may be provided on one or more spools to rotatably secure the spools together.

The spools are preferably independently rotatable so that cable or fibre can be wound onto each spool independently of the other spool.

The spools may be cylindrical and include an opening to allow fibres to pass from the spool to the front face.

The spool may further comprise integral clips for mounting spliced connectors.

### BRIEF DESCRIPTION OF THE DRAWINGS

The invention will now be described by way of example and with reference to:

FIG. 1 which shows fibres retained in accordance with the method of the present invention;

FIG. 2 which shows an example of using the invention within a housing of an electrical device;

FIG. 3 which shows a front perspective view of a fibre management enclosure embodying a further aspect of the invention;

FIG. 4 shows a rear perspective view of the fibre management enclosure; and

FIG. 5 shows a rear view of the fibre management enclosure.

### DESCRIPTION

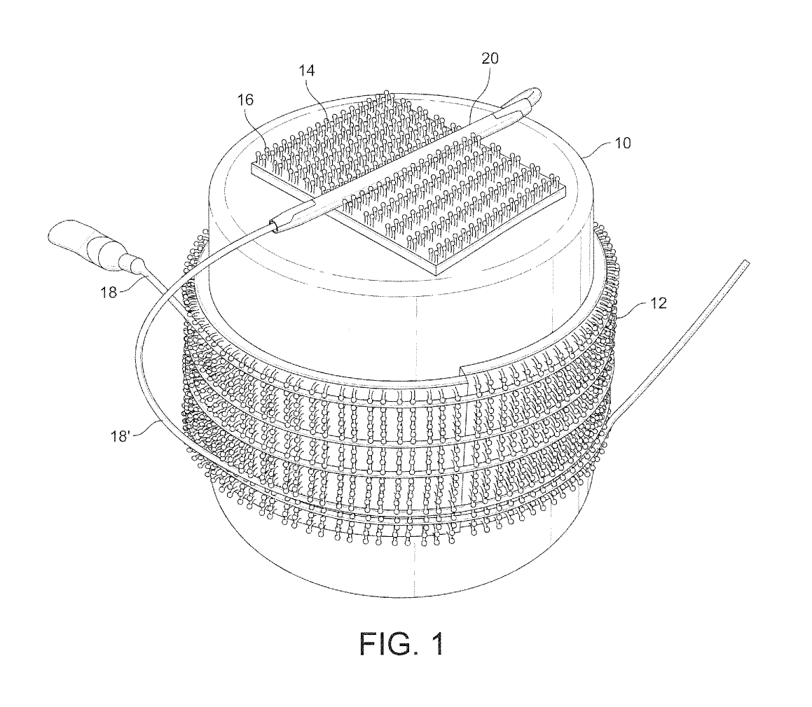

FIG. 1 shows an exemplary article or object 10, in this case a cylindrical spool, to which for illustrative purposes hook strips 12 and 14 have been attached to vertical and horizontal surfaces respectively, typically by adhesive incorporated onto the backing of the strips. Hook strips 12, 14 are part of an interlocking fastener, such as 3M® Dual Lock® or similar used in their unmated condition. Each strip comprises an array of orthogonal intersecting rows of mushroom-type hooks 16 approximately 2 mm in height with typically a 1.5 mm spacing between rows of hooks along one direction and a 2 mm spacing in the orthogonal direction. This allows different diameter elongate elements such as cables, connectors, wires and fibres to be accommodated depending on which orientation the hook strip is used in. In this illustration, the width of the strip is 25 mm and the strip is cut to a desired length.

As will be seen in FIG. 1, in one orientation, hook strip 12 retains narrower fibres such as glass fibres 18, 18′ and in the other orientation as for strip 14 is capable of retaining wider diameter elements such as splice connector 20. The hooked elements 16 of hook strips 12, 14 are flexible to grip gently but firmly cables, wires, fibres and connectors with a variety of different diameters. It is simple to push one or more fibres or cables of suitable diameter into the hook strip with the cables held securely and tidily without tangling and yet being readily removable for repositioning or replacement as and when required. Each portion of hook strip can retain a plurality of elongate elements, or one element several times, for example if the elongate element is wound around a spool as shown. The number of elements able to be retained depends on the area of hook strip provided. When the elongate elements need to be detached, the attachment provided by the hooked elements is secure but not resistant to release and so avoids stressing the elongate elements which is particularly important for preventing damage to elements such as glass fibres.

By using hook strip in this way, cable management is possible for any surface or within any interior volume without the need for separate structures designed to hold the cables, fibres or wires alone. The hook strip can be configured into any shape or size by cutting or joining different elements of hook strip and can secure elongate elements in multiple planes and positions within or with respect to an object requiring such elongate elements. This ensures that cable management can be provided in a compact way regardless of the size or space available.

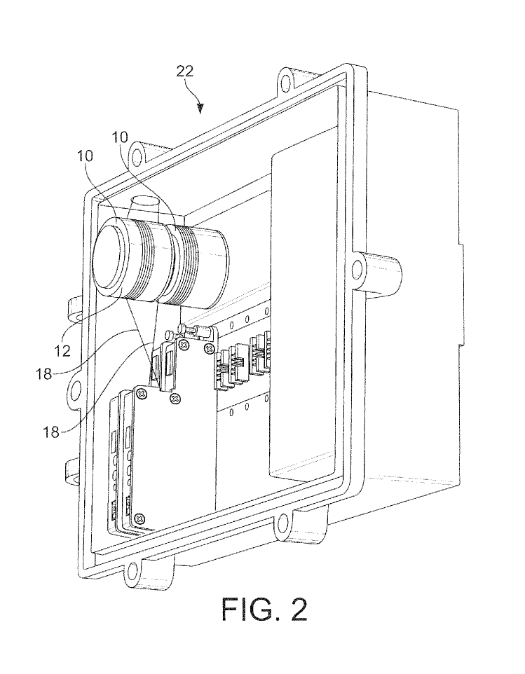

To illustrate how to provide cable management, an exemplary amplifier lid housing 22 is shown in FIG. 2 with two spools 10 vertically stacked and to which hook strip 12 is attached. The amplifier housing 22 is compact with an internal depth of around 55 cm and by using hook strip around the spools, fibres 18 can be secured within the housing in a compact and space saving way with the spools ensuring the glass fibres are maintained at a correct bend radius. Up to eight glass fibres can be securely retained by including additional pairs of spools and by attaching further fibres to hook strip on the lid (not shown) of the housing. In this particular implementation, a 1 metre fibre is wound continuously around one spool so that four fibres can be contained in housing 22 with a splice connector imbedded in horizontally orientated hook strip if required. Any interior or exterior surface can be used for cable management regardless of orientation as the hook strip will securely grip elongate elements even when applied to a ceiling of an enclosure.

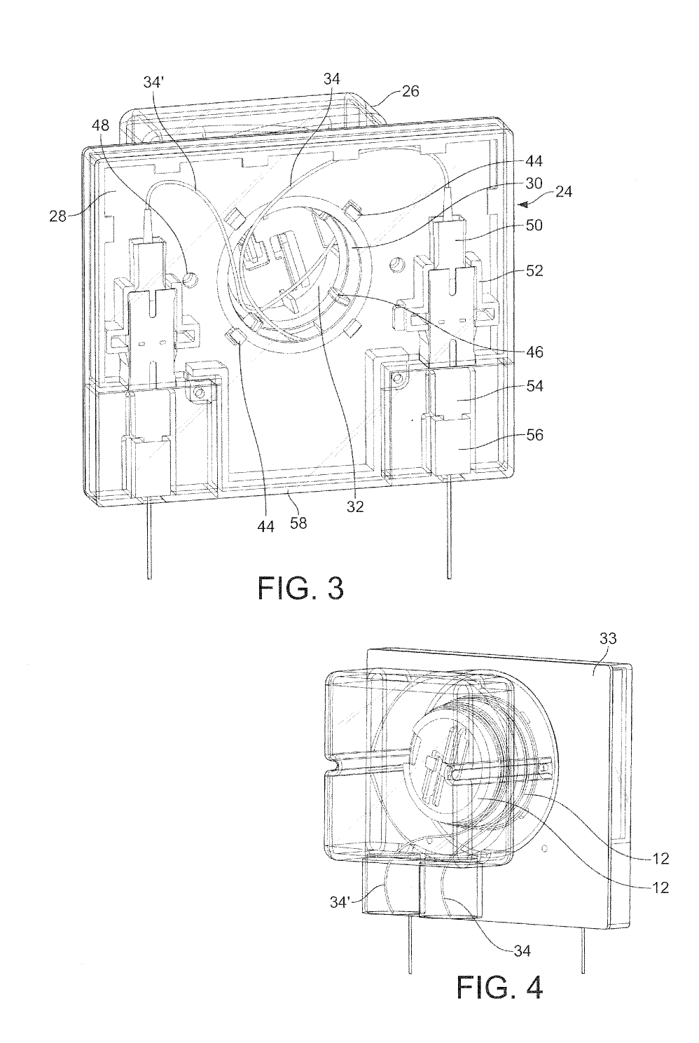

Another implementation of cable management in accordance with the present invention is shown in FIGS. 3 to 6. In FIG. 3, a fibre management enclosure 24 (only the base plate of which is shown for ease of view) is mounted to a wall box 26 embedded in a wall. Embedded wall boxes are used to provide access to fibres and cables carried within conduits or building voids with the open face of wall box 26 mounted flush with the surface of a wall in which it is situated. Conduit in the wall (not shown) connects to openings on the bottom of box 26 with fibres and cables routed through the conduit to be retained within wall box 26 for ease of access.

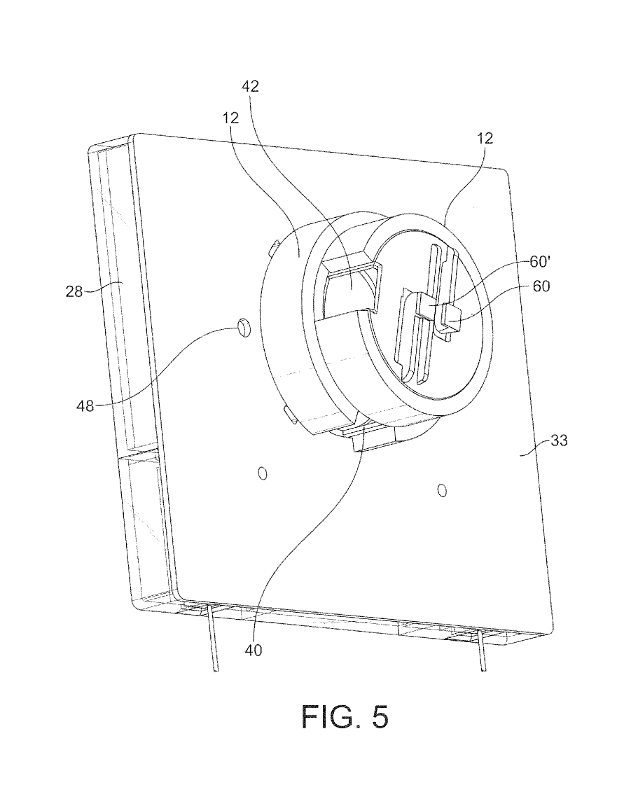

Base plate 28 of fibre management enclosure 24 has an aperture in which cylindrical rotating spools 30, 32 are located, spools 30, 32 stacked along a common central axis and extending from rear face 33 of base plate or mounting plate 28. As shown in FIGS. 4 and 5, hook strip 12 is attached to the outer faces of spools 30, 32 to retain glass fibres 34, 34′. Once base plate 28 is secured to embedded wall box 26, spools 30, 32 are positioned within the embedded wall box 26.

Conventionally any spare fibre required by the installer of the fibre management enclosure is loosely coiled within fibre management box 24 so that it can be accessed easily without needing to remove the base plate and access wall box 26. To accommodate the spare fibre, enclosure 24 has to have sufficient depth to accommodate two layers, a bottom layer where spare fibre is coiled and a top layer where connectors are mounted. However a fibre management box in accordance with the invention has a reduced depth or height as spare fibre is be stored on the rotatable spools in a manner allowing easy access to the fibre when needed whilst utilising at least some of the volume of the embedded wall box 26.

The rear of mounting plate 28 is shown in detail in FIG. 5. Independently rotatable cylindrical top and bottom spools 30, 32 are moulded from plastics material, with an aperture 40, 42 provided in each spool to allow fibres to pass through the spools and into box 24. The two spools 30, 32 form a stacked unit which can be clipped into mounting plate 28 by four retaining clips 44 which allow top spool 30 to rotate relative to plate 28. Bottom spool 32 has a smaller diameter than top spool 30 and is integrally formed with spigots 46 which locate within top spool 30 so that both spools 30, 32 are able to rotate independently of each other. Whilst the embodiment shown illustrates the use of two stacked spools, if required only one spool, or more spools can be used.

In use, the end of a fibre required to connect to an external output is passed through aperture or slot 40, 42 in either spool 30 or 32, with the enclosure base plate 28 free of the wall box 26. The fibre is wound carefully onto the outside of the spool by manually gripping the outside of the spool and rotating it, with the fibre held in place by hook strip 12 as it is wound onto the spool. When only a few centimetres of fibre are left, the fibre is wound onto the spool by rotating the spool from the inside, i.e. the surface in which locating spigots 46 are formed. Once most of the fibre has been wound onto the spool or spools, base plate 28 is placed in its final position and secured to box 26 by attaching screws through mounting holes 48. The fibres 34, 34′ are connected to connectors 50, mounted into mounting points 52 so as to communicate with output fibre connectors 54. Foam “strain-relief” blocks 56 are usually also provided. Once the connectors are connected, a protective housing (not shown) is attached to front face 58.

The connectors can be of any type, although SC-APC (standard connector-angled physical contact) are shown. If access is required to two separate fibres for two different connectors, then these are wound onto separate spools, as shown.

Whilst connectors are sometimes mounted on the ends of optical fibres, where no connector is provided the fibre needs splicing into a connector using a splice, with the splice or join in the fibre typically mounted inside a glass tube of dimensions 2.5 mm×45 mm. If required, splice holders or splice mounting clips 60, 60′ can be provided by a plastics plate that locates within the end of the spool assembly furthest from the base plate 28, see FIG. 5, the clips 60, 60′ securing splice holders within the interior of box 26.

The enclosure 24 stores cable or fibre in an ordered way on the rotatable spools 30, 32 within the void associated with wall box 26, ensuring that the cable or fibre does not need to be stored in the enclosure itself and so allowing the depth of enclosure 24 to be reduced. When spare fibre is required, for example when connectors on the ends of the fibres need replacing, the fibre can be pulled gently and released from the rotating spools, so providing easy access to the fibre without needing to remove the base plate 28.

1. A method of retaining elongate elements comprising attaching a hook strip to a surface and placing one or more elongate elements onto the hook strip so as to be removably secured by the hook strip.

2. A method of retaining elongate elements according to claim 1, wherein the hook strip comprises a number of upstanding catch elements to retain the elongate elements.

3. A method of retaining elongate elements according to claim 2, wherein the upstanding catch elements are formed in rows.

4. A method of retaining elongate elements according to claim 2, wherein the hook strip is a mushroom-type hook strip.

5. An article requiring cable management which has an attachment surface, wherein a hook strip of an interlocking fastener is attached to the attachment surface to allow elongate elements to be removably secured.

6. An article according to claim 5, wherein the hook strip comprises a number of upstanding catch elements.

7. An article according to claim 6, wherein the upstanding catch elements are formed in rows.

8. An article according to claim 6, wherein the hook strip is a mushroom-type strip.

9. A fibre management device comprising a base plate having a rear face for attachment to a support and a front face for receiving a housing, wherein the base plate comprises one or more rotatable spools extending from the rear face, the rotatable spools having attachment means for receiving cables or fibres.

10. A fibre management device according to claim 9, wherein the attachment means is hook strip.

11. A fibre management device according to claim 10, wherein the hook strip comprises a number of upstanding catch elements.

12. A fibre management device according to claim 11, wherein the upstanding catch elements are formed in rows.

13. A fibre management device according to claim 11, wherein the hook strip is a mushroom-type strip.

14. A fibre management device according to claim 9, wherein two or more rotatable spools are provided, the spools stacked along a common axis.

15. A fibre management device according to claim 14, wherein the spools are independently rotatable.

16. A fibre management device according to claim 15, wherein the spools are cylindrical and include at least one opening to allow fibres to pass from the spool to the front face.

17. A fibre management device according to claim 16, wherein clips are provided for mounting spliced connectors.
